(19) United States
(12) Patent Application Publication
(10) Pub. No.: US 2025/0314911 A1
(43) Pub. Date: Oct. 9, 2025

(54) MODULARIZED SMART GLASSES WITH CAMERA

(71) Applicant: SOLOS TECHNOLOGY (SHENZHEN) LIMITED, Shenzhen (CN)

(72) Inventors: Chiu Ming So, Shenzhen (CN); Tsz Fung Lo, Shenzhen (CN); Wai Kuen Cheung, Shenzhen (CN)

(21) Appl. No.: 18/939,543

(22) Filed: Nov. 7, 2024

(30) Foreign Application Priority Data
Apr. 3, 2024 (CN) 202420686747.6

(51) Int. Cl. G02C 5/14; G02C 5/22; G02C 11/00; G02C 11/04

(52) U.S. Cl. CPC G02C 5/146; G02C 5/22; G02C 11/04; G02C 11/10; G02C 2200/08

(57) ABSTRACT

Modularized smart glasses with camera are provided, which include a front frame, two hinges pivotally connected with two ends of the front frame, and two temples detachably installed on rear ends of the two hinges. A front end of at least one hinge is integrated with a camera, when the smart glasses are unfolded, front ends of the hinges face the front frame, and positions of the front frame corresponding to the front ends of the hinges are provided with light-transmissive areas. Driving circuits for driving camera are integrated inside the hinges or temples. Thus, the front frame does not need to be integrated with electronics. The electronics such as battery, camera and LED/light are integrated in the hinges and/or temples. Users can select modules with desired functions to assemble, and easily detach the corresponding modules for replacement or upgrading when the smart glasses need repair or upgrade.

### CROSS REFERENCE TO RELATED APPLICATIONS

This application claims priority to Chinese Patent Application No. 202420686747.6, filed Apr. 3, 2024, which is hereby incorporated by reference herein as if set forth in its entirety.

### BACKGROUND

### 1. Technical Field

The present disclosure generally relates to the technical field of smart glasses, and in particular to modularized smart glasses with camera.

### 2. Description of Related Art

As information technology has advanced and the concept of Internet of Things has popularized, the smart wearable device has been an indispensable part of people's daily lives. Especially in the field of visual assistance, the smart glasses, as a wearable device that integrates high-tech elements, are gradually changing the ways of people obtaining information, conducting social interactions and performing daily tasks.

The smart glasses provide the user with a new interactive experience by combining the technologies of augmented reality, virtual reality and mixed reality with the mobile computing platforms. These devices can not only display information, navigate, take pictures and video, but also capture environmental data through built-in sensors and cameras, so as to realize the intelligent interaction with the user.

However, most of the various smart glasses on the market, lack flexibility and personalization in design and functionality. Functions are preset by the device manufacturers, and it is often difficult that the user customizes the smart glasses according to his or her specific needs and preferences.

In addition, with the rapid iteration of the technology, shortly after purchasing a product, the user may find that the purchased product's functions no longer meet his or her current needs, and at this time, the user can only purchase new smart glasses with updated functions.

### SUMMARY

The present disclosure provides modularized smart glasses with camera, improves the customizability of the device, and allows a user to easily replace or upgrade various components of the smart glasses according to his or her needs and preferences.

An embodiment of the present disclosure provides modularized smart glasses with camera. The modularized smart glasses include a front frame, two hinges and two temples; wherein two ends of the front frame are respectively provided with first connection portions, front ends of the two hinges are respectively provided with second connection portions, and the second connection portions of the two hinges are respectively pivotally connected with the two first connection portions of the front frame, and front ends of the two temples are respectively detachably installed on rear ends of the two hinges;

a front end of at least one hinge is integrated with a camera, wherein when the hinge is in an unfolded state relative to the front frame, the front end of the hinge faces the front frame, and a light-transmissive area is provided at a position corresponding to the front end of the hinge on the front frame;

driving circuits configured for driving the camera to work are integrated inside the hinge or the temple; and

the two hinges are electrically connected through a cable, a cable groove is provided in the front frame, the cable is laid in the cable groove, and two ends of the cable are respectively embedded within the two hinges.

Further, the second connection portions are positioned on inner surfaces of the front ends of the two hinges.

Further, the first connection portions and the second connection portions are provided with connecting holes, and each hinge is pivotally connected to the front frame by inserting pins/screws through the connection holes of the first connection portions and the second connection portions.

Further, the first connection portions and the front frame are designed separately, with the first connection parts being detachably arranged at the ends of the front frame.

Further, a Light-emitting Diode (LED)/light is integrated inside a front end of one hinge, the driving circuits are configured for controlling the LED/light to realize functions of indicating and/or flashing through a preset driving manner, and the camera is integrated inside a front end of another hinge.

Further, cameras are integrated inside the front ends of the two hinges.

Further, both a LED/light and the camera are integrated inside one of the two hinges.

Further, the two ends of the front frame respectively extend outward to form limit walls, and when the hinge rotates to a position contacting with the limit wall, the limit wall blocks the hinge from continuing to rotate; and the light-transmissive area is positioned in the limit wall.

Further, the light-transmissive area is a gap, a through hole, or an open-area with light transmitting material.

Further, the front ends of the two temples are respectively plugged with the rear ends of the two hinges through USB Type-C interfaces.

Further, a sensor is provided on the hinge or the temple, the sensor is configured for detecting relative position states of the hinge and the front frame, a controller is integrated inside the hinge or the temple, the sensor is electrically connected with the controller, and when the sensor detects that the hinge is in the unfolded state relative to the front frame, the controller controls the camera to turn on.

Further, the hinge is waterproof as a whole; outside walls of the first connection portions are provided with metal grooves, one end of each of the metal grooves is connected to the cable groove in the front frame, and other end of each of the metal grooves is connected to the second connection portion; and the cable is led out from the cable groove and reaches the second connection portions through the metal grooves, the two ends of the cable are respectively embedded within the two hinges, and heads of the two ends of the cable are electrically connected with electronics inside the hinges.

Compared with the prior art, the present disclosure has the following beneficial effects:

the modularized smart glasses provided in the present disclosure include a front frame, two hinges and two temples. The front frame does not need to be integrated with electronics, and can be manufactured by integral moulding. The electronics such as battery, camera, LED/light, and other electronics are integrated inside the hinges and/or temples. The user can select modules with desired functions according to his or her needs and preferences, and further assemble the selected modules together, so as to customize the smart glasses that meet his or her needs and preferences. Furthermore, the user can easily remove the corresponding modules to replace or upgrade them when the product needs to be repaired or upgrade.

### BRIEF DESCRIPTION OF THE DRAWINGS

FIG. 1 is a structure schematic diagram of modularized smart glasses with camera in an unfolded state according to one embodiment of the present disclosure;

FIG. 2 is a schematic diagram of exploded structure of the modularized smart glasses shown in FIG. 1;

FIG. 3 is a front view of the modularized smart glasses shown in FIG. 1;

FIG. 4A is an exploded schematic diagram of a front frame and a first connection portion according to one embodiment of the present disclosure;

FIG. 4B is a schematic diagram of the front frame and the first connection portion as shown in FIG. 4A connected together by screws;

FIG. 5 is a schematic diagram of two hinges of the modularized smart glasses shown in FIG. 1 connected by a cable;

FIG. 6 is an assembly diagram of the cable and metal grooves when the modularized smart glasses shown in FIG. 1 are in an unfolded state;

FIG. 7 is an assembly diagram of the cable and the metal grooves when the modularized smart glasses shown in FIG. 1 are in a folded state;

FIG. 8 is a structure schematic diagram of modularized smart glasses with camera in a folded state according to one embodiment of the present disclosure.

### DETAILED DESCRIPTION

In order to make the purpose, technical solution and advantages of the present disclosure clearer, the present disclosure is further described in detail below in conjunction with the drawings and embodiments. It should be understood that the embodiments described here are only used to explain the present disclosure and are not used to limit the present disclosure.

In the description of the present disclosure, it should be noted that the orientation or positional relationship indicated by the terms “center”, “upper”, “lower”, “left”, “right”, “front”, “rear”, “vertical”, “horizontal”, “inside”, “outside”, etc. is based on the orientation or positional relationship shown in the drawings, and is only for the convenience of describing the present disclosure and simplifying the description, the above orientation or positional relationship does not indicate or imply that the device or element referred to must have a specific orientation, be constructed and operated in a specific orientation, and therefore cannot be understood as a limitation on the present disclosure. The terms “first”, “second”, “third”, and the like are only used for distinguishing, and cannot be understood as indicating or implying relative importance. In addition, unless otherwise specified and limited, the terms “install”, “connected with”, and “connected to” shall be understood broadly, e.g., as a fixed connection, a detachable connection, or an integral connection; as a direct connection, an indirect connection through an intermediary, or a connection between two parts. For those skilled in the art, the specific meanings of the above terms in the present disclosure can be understood under specific circumstances.

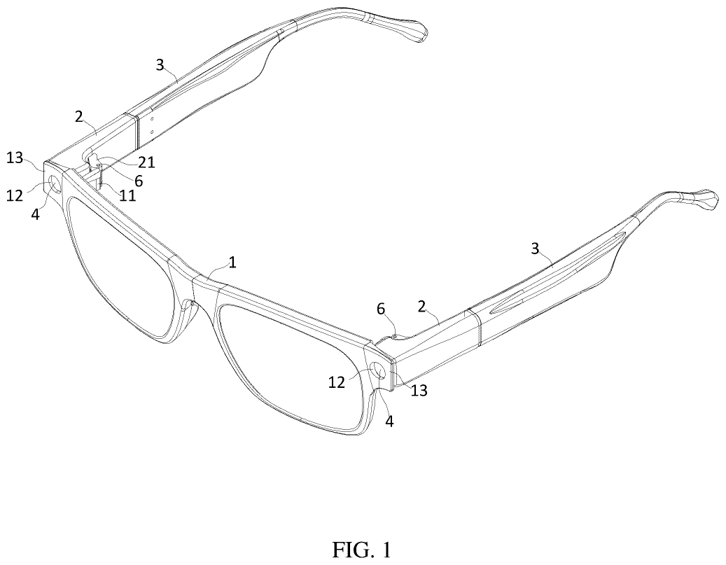

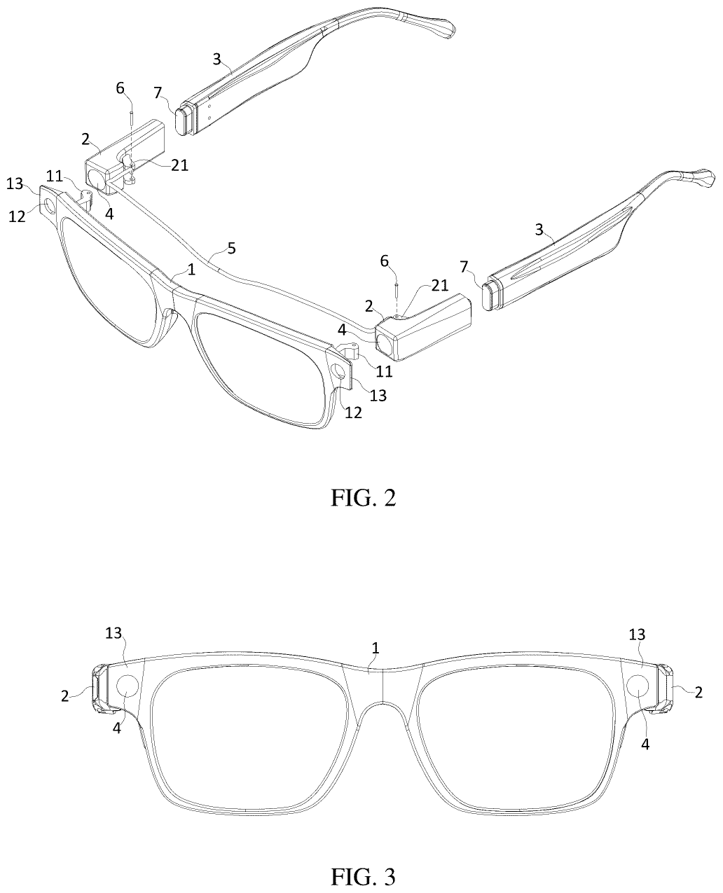

Referring to FIG. 1 and FIG. 2, modularized smart glasses with camera are provided according to one embodiment of the present disclosure, and the modularized smart glasses include a front frame 1, two hinges 2, and two temples 3.

Each of inner sides (i.e., the sides facing the head of the human body) of two ends of the front frame 1 is provided with a first connection portion 11. Each of inner sides of front ends of two hinges 2 is provided with a second connection portion 21. The second connection portions 21 of the two hinges 2 are pivotally connected with the two first connection portions 11 of the front frame 1, respectively. The front ends of the two temples 3 are detachably installed at the rear ends of the two hinges 2, respectively.

The front ends of the two hinges 2 are integrated with cameras 4. When the hinges 2 are in an unfolded state relative to the front frame 1, the front ends of the hinges 2 face the front frame 1, and light-transmissive areas 12 are provided in the positions of the front frame 1 corresponding to the front ends of the two hinges 2, so that the light rays in front of the front frame 1 can pass through the light-transmissive areas 12 and enter the cameras 4.

The driving circuits used for driving the cameras 4 to work are integrated inside the hinges 2 or the temples 3.

It is understandable that the above only illustrates the application mode in which the two hinges 2 are integrated with the cameras 4. In order to realize the diversity of functions of the hinge 2 to assemble smart glasses with more diverse functions, in other embodiments, at least one LED/light may be integrated inside the front end of one hinge 2, the driving circuits may control the at least one LED/light to realize functions of indicating and/or flashing through a preset driving manner, and the camera 4 may be integrated inside the front end of another hinge 2. In other embodiments, both the at least one LED/light and the camera 4 may be integrated inside one hinge 2, and the camera 4 may be integrated inside the front end of another hinge 2 (i.e., no LED/light is integrated inside another hinge 2). When the LED/light is integrated in the front end of the hinge 2, the light emitted by the LED/light can be transmitted out through the light-transmissive area 12 in the front frame 1.

The above-mentioned at least one LED/light may include only one type of LED/light, and the driving circuits control the LED/light to indicate the working states of the smart glasses according to corresponding lighting manner. For example, the driving circuits control the LED/light to light up and indicate in green when the smart glasses receive information, the driving circuits control the LED/light to light up and indicate in red when a touch action of the user on the smart glasses is detected, and the driving circuits control the LED/light to flash when the camera 4 of the smart glasses is taking photos or videos.

The above-mentioned at least one LED/light may include two types of LEDs/lights, the first LED/light is controlled to light up and indicate in a corresponding color when the smart glasses receive information or are touched, and the second LED/light is controlled to flash when the camera 4 is taking photos or videos.

Further, the driving circuits for driving the camera(s) 4 may be the same as the driving circuits for driving the at least one LED/light, for example, a SCM (Single-Chip Microcomputer) is used as the driving circuits, and the at least one LED/light and the camera(s) 4 are controlled by different ports or the same port of the SCM. Alternatively, the above-mentioned driving circuits includes two types of driving circuits, the first driving circuit is used to drive the camera(s) 4, and the second driving circuit is used to drive the at least one LED/light.

Preferably, the two ends of the front frame 1 respectively extend outward to form limit walls 13. When the hinges 2 rotates to the positions contacting with the limit walls 13, the limit walls 13 can block the hinges 2 from continuing to rotate, and the light-transmissive areas 12 are positioned in the limit walls 13. Each light-transmissive area 12 may be a gap, a through hole, or an open-area with light transmitting material, and the light transmitting material may be transparent material, or colored translucent material. As shown in FIG. 3, each light-transmissive area 12 is a through hole, when the smart glasses are in the unfolded state, the camera 4 in the front end of the hinge 2 faces the through hole.

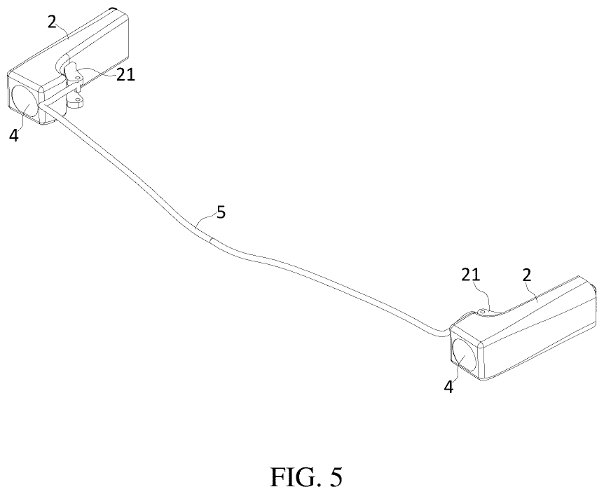

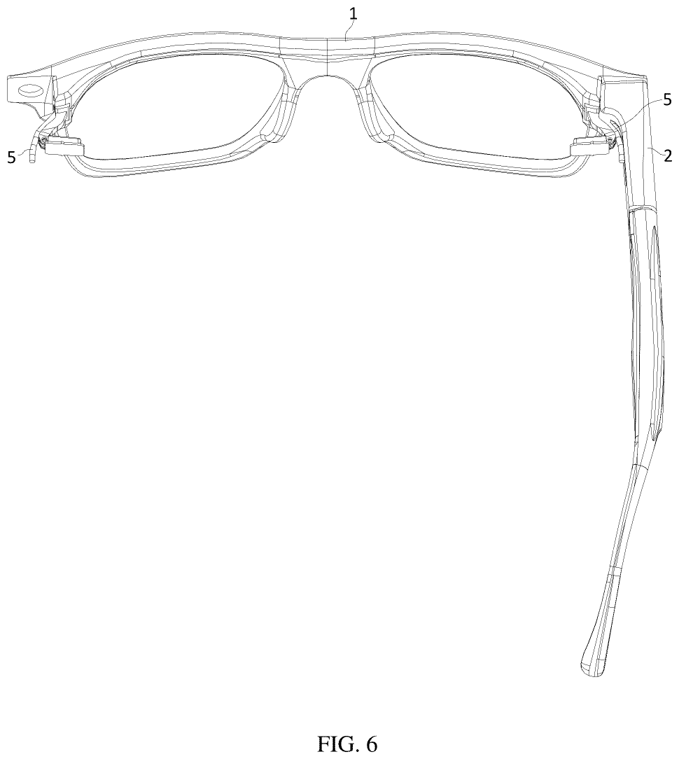

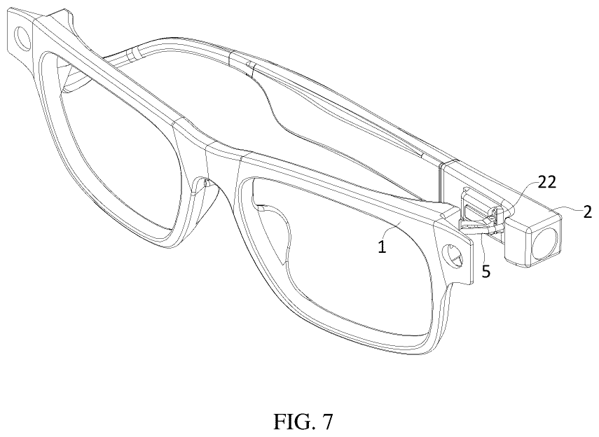

As shown in FIG. 5 and FIG. 6, the electronics in the two hinges 2 are electrically connected via a cable 5. Specifically, a cable groove is provided in the front frame 1, the cable 5 is laid in the cable groove, and the hinge 5 is waterproof as a whole. Referring to FIG. 7, the outside wall of the first connection portion 11 is provided with a metal groove 22, one end of the metal groove 22 is connected to the cable groove in the front frame 1, and other end of the metal groove 22 is connected to the second connection portion 21, the cable 5 is led out from the cable groove of the front frame 1 and reaches the second connection portion 21 through the metal groove 22. Finally, the two ends of the cable 5 are respectively embedded within the two hinges 2, and heads of the two ends of the cable 5 are electrically connected with the electronics inside the hinges 2. The “outside wall” of the metal groove 22 is a sidewall away from the user's skin when worn, correspondingly, the “inside wall” is a wall surface in contact with or adjacent to the user's skin when worn, and the “inside wall” is opposite to the “outside wall”. Further, in FIG. 7, the cable 5 shields the metal groove 22, and the metal groove 22 is positioned behind the cable 5.

The metal grooves 22 of the first connection portions 11 can clamp and limit the cable 5, so as to prevent the heads of ends of the cable 5 electrically connected with the hinges 2 from loosening during the unfolding or folding of the smart glasses, in addition, the cable 5 may also be hidden in the metal grooves 22, for more beautiful appearance.

The front frame 1 and the hinges 2 are pivotally connected, and the hinges 2 and the temples 3 are in the unfolded state or folded state relative to the front frame 1 by rotating the hinges 2 and the temples 3. In this embodiment, an easily-detachable hinge structure is adopted to realize pivotally connecting. Specifically, connecting holes are provided in the first connection portions 11 of the front frame 1 and the second connection portions 21 of the hinges 2, and the two hinges 2 and the front frame 1 are hinged by inserting pins (or screws) 6 into the connecting holes of the first connection portions 11 and the connection portions 21. In order to reinforce the connection relationship between the front frame 1 and the hinges 2, an external thread may further be provided at the bottom end of each pin (or screw) 6, an internal thread is provided in each connecting hole of the second connection part 21 of each hinge 2, and the pins (or screws) 6 are connected to the hinges 2 through the threads. The connection between the front frame 1 and the hinges 2 is released by unscrewing the pins (or screws) 6, and the user can freely replace new hinge(s) or hinge(s) with other functions. It should be noted that, in other embodiments, the front frame 1 and the hinges 2 may be connected in other ways, which can realize the pivotally connecting, for example, using the flexible connectors and snap-fit structures to connect the front frame 1 and the hinges 2 can also realize the rotation function and easily-detachable function.

In this embodiment, the hinges 2 and the temples 3 may be detachably connected by means of plug-in. As shown in FIG. 2, the front end of the temple 3 is plugged with the rear end of the hinge 2 through USB Type-C interface 7. After plugging, the temple 3 is installed on the hinge 2 and electrically connected to the hinge 2. The user can easily pull out each temple, and replace it with a new hinge 2 or temple 3, or a hinge 2 or temple 3 with other functions. It should be noted that, in other embodiments, the hinge 2 may be detachably connected with the temple 3 through interference sleeve connection, snap-fit connection, and the like.

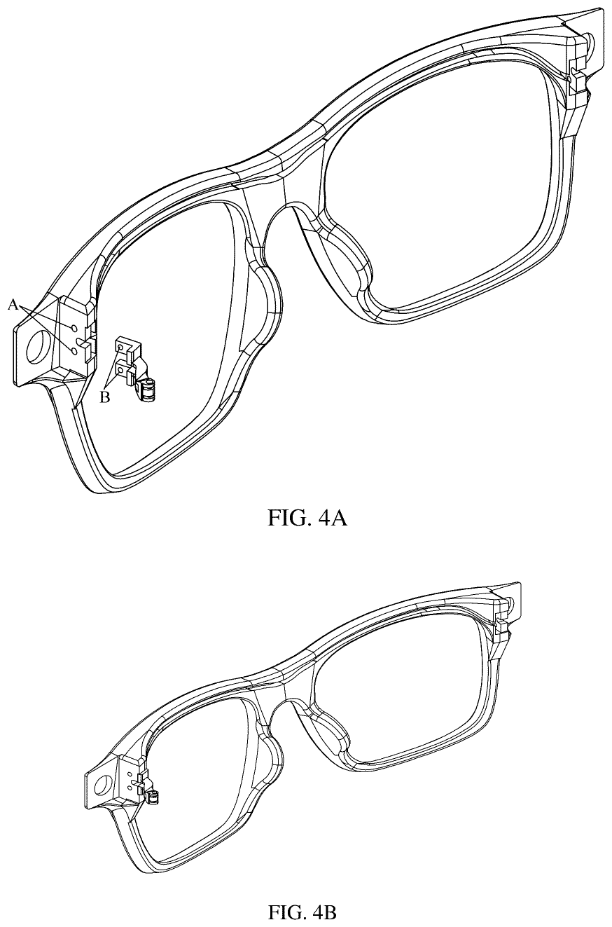

As an implementation, the first connecting portions 11 adopt a separate design from the front frame 1, with the first connecting portions 11 being detachably arranged at the end parts of the front frame 1. Referring to FIGS. 4A and 4B, the front frame 1 has the first screw holes A, and the front end of the first connecting portion 11 has the second screw holes B, the first screw holes A and the second screw holes B are aligned and then are fixed by screws, so as to realize the fixed connection between the first connecting portion 11 and the front frame 1. In this design, the above-mentioned connecting holes are positioned in the rear ends of the first connecting portions 11, to realize the hinge joint with the hinges 2.

It should be noted that, the first connecting portions 11 may also be directly injection molded with the front frame 1, and are formed an integrated structure with the front frame 1. Specifically, the first connecting portions 11 and the front frame 1 may be made of the same material by one-time injection molding, or the first connecting portions 11 and the front frame 1 may be made from different materials by using the secondary injection molding process.

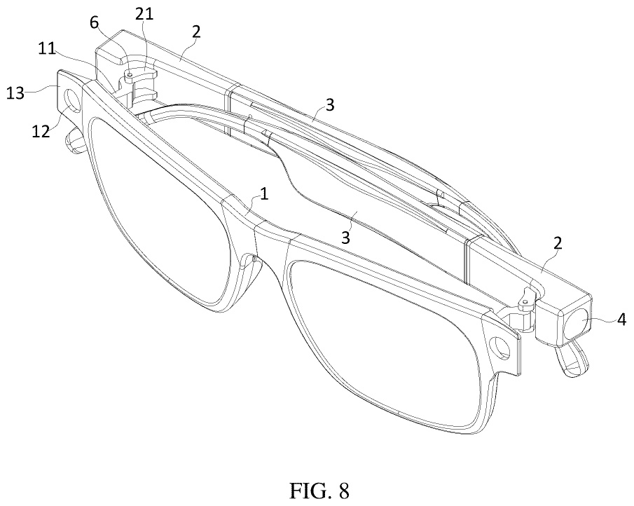

A sensor for detecting the relative position state between the hinge 2 and the front frame 1 is provided in the hinge 2 or the temple 3. Preferably, the sensor is positioned between the hinge 2 and the front frame 1, and may be a photoelectric sensor, pressure sensor, distance sensor, or other types of sensors. A controller is integrated inside the hinge 2 or the temple 3, and the sensor is electrically connected with the controller. When the sensor detects that the hinge 2 is in the unfolded state relative to the front frame 1, the controller controls the camera to turn on. When the sensor detects that the hinge 2 is in the folded state (as shown in FIG. 8) relative to the front frame 1, the controller controls the camera 4 to turn off.

In summary, in this embodiment, the front frame 1, the hinges 2 and the temps 3 are modularly designed, the modules are connected together in an easily detachable way, the front frame 1 does not need to be integrated with the electronics and can be manufactured by integral moulding, and the electronics such as battery, camera 4, LED/light, and other electronics are integrated in the hinges 2 and/or temples 3. Accordingly, the user can select modules with desired functions according to his or her needs and preferences, and assemble the selected modules together, so as to customize the smart glasses that meet his or her needs and preferences. Furthermore, when the product needs to be repaired or upgrade, the user can easily remove the corresponding modules to replace or upgrade them.

The above description is only a preferred embodiment of the present disclosure and is not intended to limit the present disclosure. Any modifications, equivalent substitutions and improvements made within the spirit and principles of the present disclosure should be included in the protection scope of the present disclosure.

What is claimed is:

1. Modularized smart glasses with camera, comprising: a front frame, two hinges and two temples, wherein,
two ends of the front frame are respectively provided with first connection portions, front ends of the two hinges are respectively provided with second connection portions, and the second connection portions of the two hinges are respectively pivotally connected with the two first connection portions of the front frame, and front ends of the two temples are respectively detachably installed on rear ends of the two hinges;
a front end of at least one hinge is integrated with a camera, wherein when the hinge is in an unfolded state relative to the front frame, the front end of the hinge faces the front frame, and a light-transmissive area is provided at a position corresponding to the front end of the hinge on the front frame;
driving circuits configured for driving the camera to work are integrated inside the hinge or the temple; and
the two hinges are electrically connected through a cable, a cable groove is provided in the front frame, the cable is laid in the cable groove, and two ends of the cable are respectively embedded within the two hinges.

2. The modularized smart glasses of claim 1, wherein the second connection portions are positioned on inner surfaces of the front ends of the two hinges.

3. The modularized smart glasses of claim 1, wherein the first connection portions and the second connection portions are provided with connecting holes, and each hinge is pivotally connected to the front frame by inserting pins or screws through the connection holes of the first connection portions and the second connection portions.

4. The modularized smart glasses of claim 3, wherein the first connection portions and the front frame are designed separately, with the first connection parts being detachably arranged at the ends of the front frame.

5. The modularized smart glasses of claim 1, wherein a Light-emitting Diode (LED) or light is integrated inside a front end of one hinge, and the driving circuits are configured for controlling the LED or light to realize functions of indicating and/or flashing through a preset driving manner; and wherein the camera is integrated inside a front end of another hinge.

6. The modularized smart glasses of claim 1, wherein cameras are integrated inside the front ends of the two hinges.

7. The modularized smart glasses of claim 1, wherein both a LED or light and the camera are integrated inside one of the two hinges.

8. The modularized smart glasses of claim 1, wherein the two ends of the front frame respectively extend outward to form limit walls, and when the hinge rotates to a position contacting with the limit wall, the limit wall blocks the hinge from continuing to rotate; and wherein the light-transmissive area is positioned in the limit wall.

9. The modularized smart glasses of claim 1, wherein the light-transmissive area is a gap, a through hole, or an open-area with light transmitting material.

10. The modularized smart glasses of claim 1, wherein the front ends of the two temples are respectively plugged with the rear ends of the two hinges through USB Type-C interfaces.

11. The modularized smart glasses of claim 1, wherein a sensor is provided on the hinge or the temple, the sensor is configured for detecting relative position states of the hinge and the front frame, a controller is integrated inside the hinge or the temple, the sensor is electrically connected with the controller, and when the sensor detects that the hinge is in the unfolded state relative to the front frame, the controller controls the camera to turn on.

12. The modularized smart glasses of claim 1, wherein the hinge is waterproof as a whole;
outside walls of the first connection portions are provided with metal grooves, one end of each of the metal grooves is connected to the cable groove in the front frame, and other end of each of the metal grooves is connected to the second connection portion; and
the cable is led out from the cable groove and reaches the second connection portions through the metal grooves, the two ends of the cable are respectively embedded within the two hinges, and heads of the two ends of the cable are electrically connected with electronics inside the hinges.
